(19) United States
(12) Patent Application Publication
(10) Pub. No.: US 2017/0070353 A1
(43) Pub. Date: Mar. 9, 2017

(54) METHOD OF MANAGING CREDENTIALS IN A SERVER AND A CLIENT SYSTEM

(71) Applicant: GEMALTO INC., Austin, TX (US)

(72) Inventors: Darmawan SUWIRYA, Austin, TX (US); HongQian Karen LU, Austin, TX (US)

(73) Assignee: GEMALTO INC., Austin, TX (US)

(21) Appl. No.: 14/848,069

(22) Filed: Sep. 8, 2015

(51) Int. Cl. H04L 9/32; H04L 9/14; H04L 29/06

(52) U.S. Cl. CPC H04L 9/3263; H04L 63/0428; H04L 9/14; H04L 67/42; H04L 2209/24; H04L 2209/64

(57) ABSTRACT

A method for deploying credentials in a server and a client system including three devices. The second device has primary credentials including a public key, a private key and a primary certificate. After successful authentication of a user, the first device generates a new private key/public key pair and wraps the new private key. After successful authentication of the user, the second device derives a new certificate comprising the new public key, the new certificate having the same usage specified in the primary certificate. The second device signs the new certificate using the private key of the primary credentials. The third device forwards to the server the primary certificate and the new credentials combining the new public key, the wrapped private key and the new certificate. The server verifies the chain of trust of the new credentials and, in case of successful verification, associates the new credentials to the user.

### FIELD OF THE INVENTION

The present invention relates to methods of managing credentials in a server and a client system. It relates particularly to methods of deploying credentials, to methods of authenticating a user to a server and to methods of signing a value by a client system.

### BACKGROUND OF THE INVENTION

In Public Key Infrastructure (PKI), credentials often require strict identity proofing process in the registration process. It provides a mechanism to produce trusted credentials with high Level of Assurance, which makes it suitable for high value transaction usage, such as strong authentication and digital signature purposes. However, PKI credentials have limitations in terms of scalability and security. Due to the strict vetting in the registration process, it introduces limitation in term of number of new credentials that can be issued at certain duration of time. PKI credentials are typically stored in secure devices that often have limited resource. This introduces limitation in term of maximum number of credentials that can be stored in a secure device. Moreover, due to the scalability limitation mentioned above, it eventually leads to security limitation too. For example, for authentication best practice, one credential should only be used for one authentication server. Otherwise, relay attacks are possible. Carrying multiple secure devices is not convenient. As a result, in practice the same credentials are often used for multiple different purposes, by multiple different applications

Therefore, there is a need to develop a new credentials system that is more secure, trusted, and scalable than existing systems.

### SUMMARY OF THE INVENTION

An object of the invention is to solve the above mentioned technical problem.

An object of the present invention is a method for deploying credentials in a server and a client system including a first, a second and a third devices. The second device comprises primary credentials including a public key, a private key and a primary certificate. After a successful authentication of a user, the first device generates a new private key/public key pair and wraps the new private key. After a successful authentication of the user, the second device derives a new certificate comprising the new public key, the new certificate having the same usage as specified in the primary certificate. The second device signs the new certificate using the private key of the primary credentials. The third device forwards to the server the primary certificate and the new credentials combining the new public key, the wrapped private key and the new certificate. The server verifies the chain of trust of the new credentials and, in case of successful verification, associates the new credentials to said user.

Advantageously, the first device and said second device may be merged in a single device.

Advantageously, the client system may send to the server a proof of genuineness of said first device.

Advantageously, the third device may comprise a user agent which is configured to receive a registration request from the server, to send to the server a registration response comprising said primary certificate and new credentials and to coordinate interaction between said first and second devices.

Another object of the present invention is a method for authenticating a user through an application to an authentication server, said application running on a client system including an authenticator device and a client device. The authentication server sends to the client system both a challenge and a bundle associated to a user for said application, said bundle including specific credentials which combine a public key, a wrapped private key and a certificate. After a successful authentication of said user, the authenticator device verifies the validity of said bundle and, in case of successful verification, unwraps the private key, and generates a cryptogram by signing the challenge with the private key. The client system sends to the authentication server the cryptogram. The authentication server verifies the cryptogram using the public key and, in case of successful verification, authenticates the user to the authentication server.

Another object of the present invention is a method for signing a value by a client system including a signing device and a client device. A server sends to the client system both the value and a bundle associated to a user, said bundle including specific credentials which combine a public key, a wrapped private key and a certificate. After a successful authentication of said user, the signing device verifies the validity of said bundle, in case of successful verification, unwraps the private key and generates a signature by signing the value with the private key. The client system sends to the server the generated signature. The server verifies the signature using the specific public key.

Another object of the present invention is a client system designed to communicate with a server and comprising a first device, a second device and a third device, the second device comprising primary credentials including a public key, a private key, and a primary certificate. The first device is configured to generate a new private key/public key pair and to wrap the new private key only in case of a successful authentication of a user. The second device is configured to derive a new certificate comprising the new public key only in case of successful authentication of said user, said new certificate having the same usage as specified in the primary certificate. The third device is configured to coordinate interaction between said first and second devices and to send to the server the primary certificate and the new credentials combining the new public key, the wrapped private key and the new certificate.

Advantageously, the client system may be configured to send to the server a proof of genuineness of said first device.

Advantageously, the first device may be configured to receive from the server a challenge and a bundle associated to the user, said bundle including specific credentials, wherein said first device may be configured to authenticate said user and to verify the validity of said bundle in case of successful authentication of said user, and wherein the first device, in case of successful verification, unwraps the private key and generates a cryptogram by signing the challenge.

Advantageously, the first device may be configured to receive from the server a value and a bundle associated to the user, said bundle including specific credentials, wherein said first device may be configured to authenticate said user and to verify the validity of said bundle in case of successful authentication of said user, and wherein the first device, in case of successful verification, unwraps the private key and generates a signature by signing the value with the private key.

### (BRIEF DESCRIPTION OF THE DRAWINGS)

Other characteristics and advantages of the present invention will emerge more clearly from a reading of the following description of a number of preferred embodiments of the invention with reference to the corresponding accompanying drawings in which:

FIG. 1 depicts a flowchart showing an example of registration sequence according to the invention,

FIG. 2 depicts a flowchart showing an example of authentication sequence according to the invention,

FIG. 3 is an example of a client system comprising two devices according to the invention, and

FIG. 4 is another example of client system comprising three devices according to the invention.

### DETAILED DESCRIPTION OF THE PREFERRED EMBODIMENTS

The invention may apply to any type of client system comprising an application intended to access a service whose access is protected by a server. The service may be a communication system, a payment system or a video/music system for example. The client system may include any type of device able to establish a communication session with the server via a wireless or wired link. For example the client system may include a mobile phone, a tablet PC, an electronic pair of glasses, an electronic watch, an electronic bracelet, a vehicle, a meter, a slot machine, a TV or a computer.

Examples of the methods according to the invention are described below in the case of the framework of Fast Identity Online (FIDO) as defined in FIDO UAF Protocol Specifications v1.0. These examples are not restrictive and the invention is not limited to the FIDO framework.

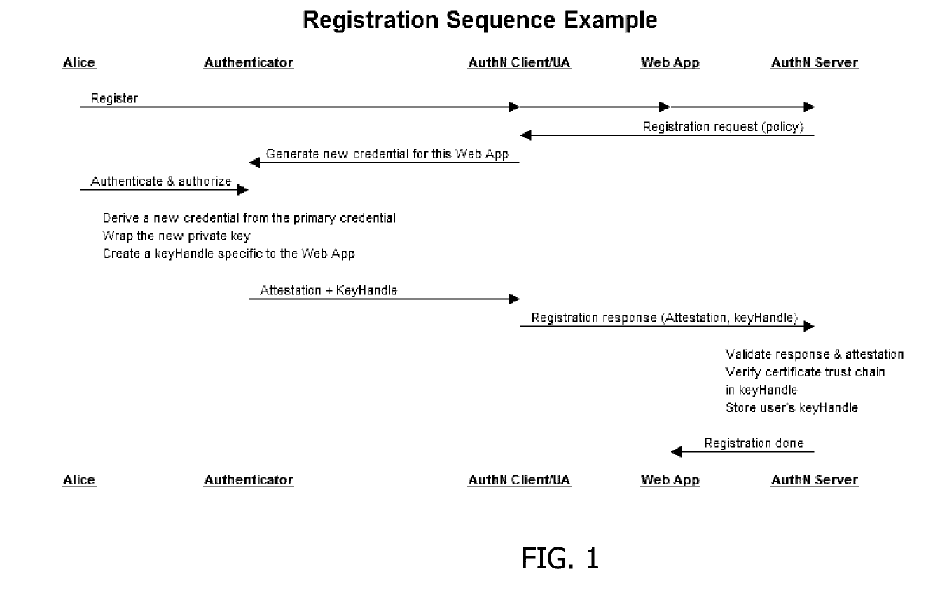

FIG. 1 illustrates an example of registration sequence according to the invention.

In this example, Alice is a user having two devices: an authentication device (Authenticator) and a device able to communicate with both the authentication device and an authentication server (AuthN Server). This device may be a personal computer including a user agent (AuthN Client/UA), running a Web Application (Web App). Preferably, the user agent is a web browser. The authentication device contains previously issued primary credentials. The client system includes both the authentication device and a personal computer.

The personal computer is able to communicate with the distant server (AuthN Server) through any kind of network. For instance, the communication may be set through a combination of a wireless channel (like Wi-Fi) and a wired channel (like Ethernet).

The user (Alice) initiates registration of her authentication device (Authenticator) to a particular web application (Web App) through the user agent (AuthN Client/UA) of her personal computer.

The Web App asks its backend authentication server (AuthN Server) to start the registration procedure. The Server sends back a Registration Request message to the user agent. In a preferred embodiment, the content of Registration Request message can be as defined in FIDO specifications. Optionally, the Registration Request message can comprise a policy which specifies a particular kind of authenticator or credential. For instance, the policy may be as described in FIDO specifications.

Then the user agent receives, verifies and interprets the Registration Request message sent by the Server. Once verified, the user agent asks the Authentication device to generate new credentials specific for this particular Web App and purpose (authentication or digital signature for instance). Prior to generating new credentials, the Authentication device asks for User authentication. This authentication can be carried out through a user gesture, PIN/Password entry or biometric measurement for instance.

Upon successful User authentication, the Authenticator begins the new credentials generation procedure which consists of the following sub-steps:

1) Generating a new key pair (i.e. a public key and a private key).

2) Generating a new certificate that contains the public key of the newly generated key pair. The Authenticator derives the new certificate from the primary certificate (i.e. the certificate of the primary credentials). The new certificate is set with the same usage as the primary certificate (like authentication or digital signature for example). The new certificate is signed with the private key of the primary credentials. Thanks to this derivation process, the server is then able to check that the new certificate derived from the certificate of the primary credentials.

3) And finally, the Authenticator wraps the private key of the newly generated key pair. This wrapping operation may be performed by encrypting the private key with a secret data which has been predefined or dynamically generated in the authentication device. The Authenticator puts the new credentials (including the new public key, the wrapped private key and the new certificate) and the certificate of the primary credential (i.e. issuer certificate) into a data structure. In a preferred embodiment, the data structure is a Key Handle structure as defined in FIDO specification, with addition of the newly generated certificate and the certificate of the primary credentials. The Authenticator then sends the data structure (Key Handle) to the user agent. Optionally, a proof of genuineness of the authentication device may be sent along with the data structure. For instance, the proof of genuineness may be an attestation as defined by FIDO specifications.

Then the user agent (AuthN Client) puts the data structure (and possibly along with the proof of genuineness received from the Authenticator) into a Registration Response message and sends it back to Server. In a preferred embodiment, the content of Registration Response message can be as defined in FIDO specifications, with some additional information.

Then the Server receives and validates the Registration Response message. In addition, the Server verifies also the chain of trust of the newly derived credentials contained in the data structure (Key Handle structure). Upon successful verification, the Server stores this data structure for this particular User and returns a Registration Success message back to the Web App. Otherwise, the Server sends back a Registration failure message.

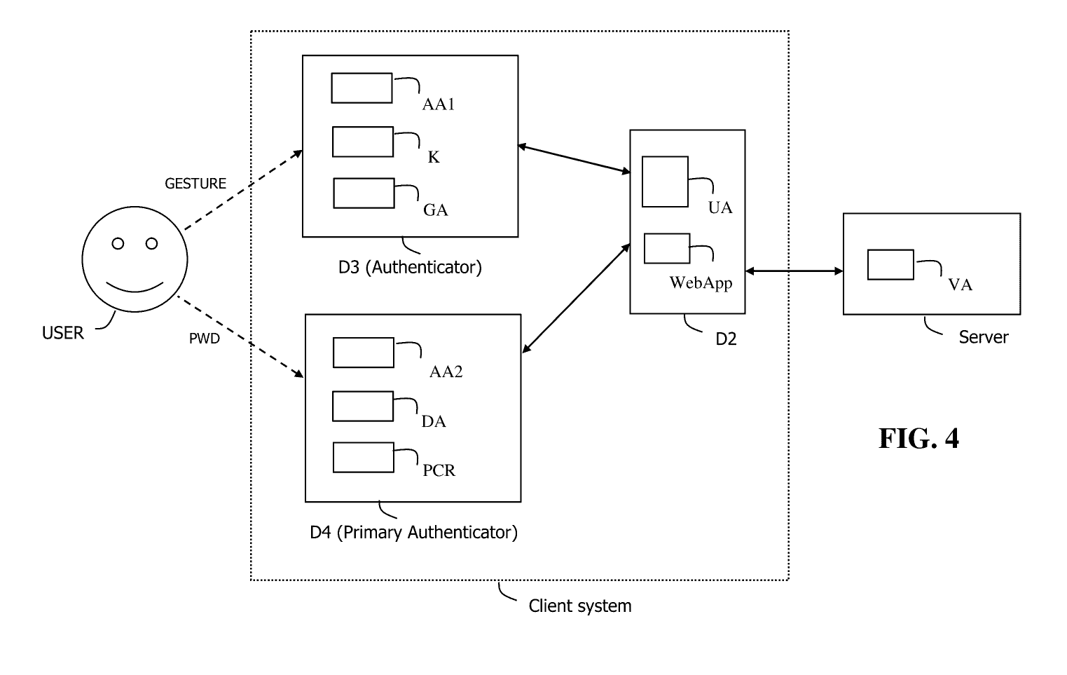

Credentials derivation process may happen on another secure device other than the one where the primary credentials reside. For example, the primary credentials may be in User's PIV (Personal Identity Verification) card, while the authenticator is in User's mobile phone. FIG. 4 provides an example of such a case.

The user agent is not limited to a browser and may be implemented as a software acting on behalf of the user for communication session like a mail reader application or any application requiring user credentials.

Depending on the purpose of the registration, the user may target a signature server for registering a signing device (instead of an authentication server for registering an authentication device as described above).

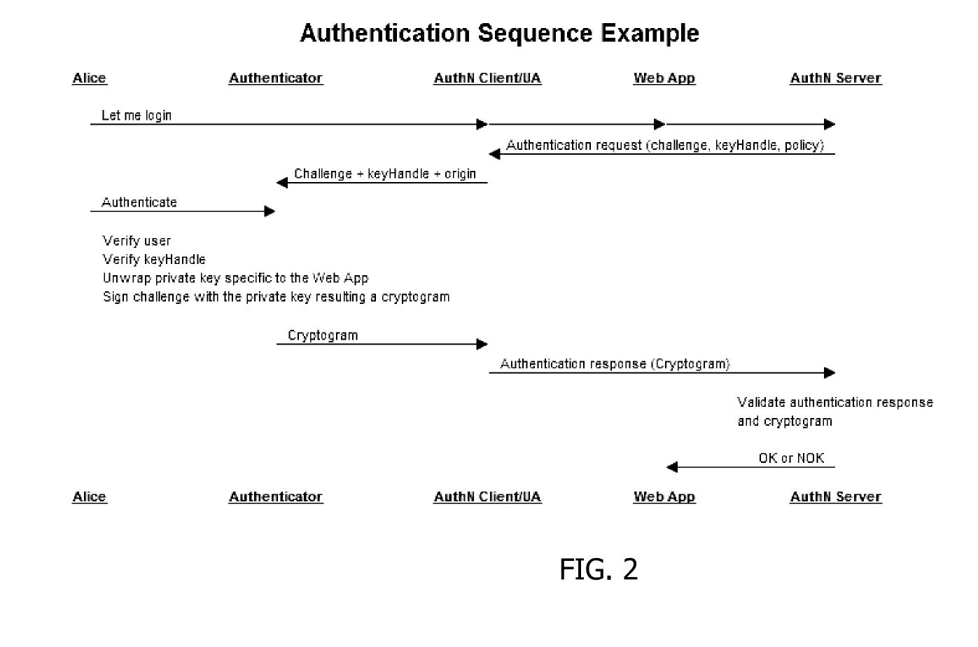

FIG. 2 illustrates an example of authentication flow according to the invention.

In this example, the registration sequence of FIG. 1 is assumed to have been executed correctly and successfully beforehand.

The user (Alice) initiates a login request to a particular web application (Web App) through a web browser (AuthN Client/UA).

The Web App asks its backend authentication server (AuthN Server) to start the authentication procedure. The Server sends back an Authentication Request message to the browser (AuthN Client). The Authentication Request message includes a challenge, a bundle, a policy, and other parameters if needed. The policy is optional and may be a policy as defined by FIDO specifications. The bundle contains the User data structure (e.g. Key Handle structure).

In one embodiment, the format of the Authentication Request message is as defined in FIDO specifications.

The browser receives, verifies and interprets the Authentication Request message sent by the Server. Once verified, the browser asks the Authentication device (Authenticator) to perform an authentication procedure specific for this particular User and Web App. For this purpose, the browser can send additional parameters like the origin of the Server to the Authenticator.

Prior to performing the authentication procedure, the Authenticator asks for User authentication (e.g. user gesture, PIN/Passphrase entry, biometric, etc.)

Upon successful User authentication, the Authenticator begins the authentication procedure which consists of the following sub-steps:

1) Verifying the integrity and validity of the received bundle. This verification can cover a check of the origin, the trust chain, and the credential purpose for instance.

2) Decrypting/un-wrapping the private key stored within the bundle,

3) and finally, computing the authentication cryptogram by signing the received challenge using the unwrapped private key. The cryptogram is then returned by the Authenticator to browser.

The browser puts the cryptogram received from the Authentication device (Authenticator) into an Authentication Response message and sends it back to the Server. In a preferred embodiment, the content of the Authentication Response message is as defined in FIDO specifications.

The Server receives and validates the Authentication Response. Upon successful verification, the Server returns an Authentication Success message back to the Web App. Otherwise, the Server sends back an Authentication failure message.

Another method according to the invention aims at providing a digital signature. The flows for digital signature are very similar to the registration and authentication flows described above. For digital signature, User registers a signing device (instead of an Authentication device) to the Server (which is also called Signature Server). Web App interacts with the Signature Server to request a User signature.

The remaining differences of the signature flows from the authentication flows include the following:
During registration the signing device derives new credentials for signing purpose,
the Server sends a document hash instead of a challenge in a Signature Request message,
the signing device produces a signature value instead of a cryptogram,
the bundle contains a new signature credentials instead of an authentication credentials
the Server forwards a valid signature value back to Web App.

The Server and the Web App can both verify the validity and the trustworthy-ness of the signature value by using the certificates of the derived and the primary credentials.

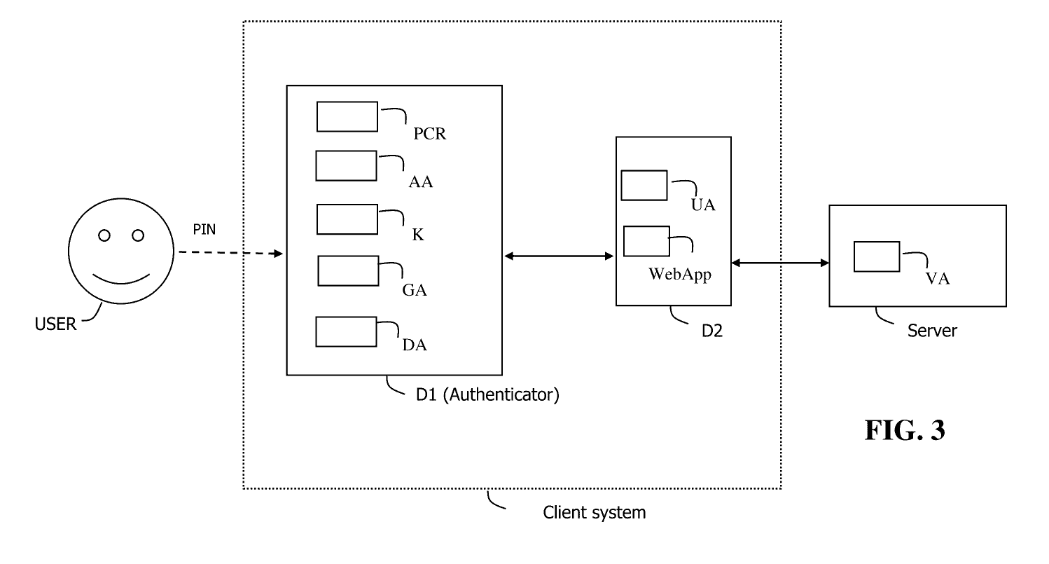

FIG. 3 illustrates an example of a client system comprising two devices according to the invention.

The client system includes an authentication device D1 and a tablet D2.

The authentication device D1 (also called authenticator) may be any electronic device with an interface allowing to get information from a user and able to communicate with the other device of the client system. For instance, the authentication device D1 may be a mobile phone which communicate with the device D2 through a Bluetooth connectivity.

The authentication device D1 stores primary credentials PCR and a secret data K which is used for wrapping/unwrapping the private key.

The authentication device Dl includes an Authentication agent AA able to get an entry from the user and to authenticate the user. For instance, the Authentication agent AA may be configured to get a PIN or Passphrase and to check it. The authentication device D1 includes a Generation agent (GA) configured to generate a new key pair only in case of successful authentication of the user. The authentication device D1 includes a Derivation agent (DA) configured to derive a new certificate from the certificate of the primary credentials (PCR) only in case of successful authentication of the user.

The tablet D2 includes a browser (UA), running a Web Application (WebApp) which is a service whose access is protected by a distant server. The server includes a Verification agent (VA) configured to perform verification operations required for registration of a user and verification operations required for authentication of a user.

FIG. 4 illustrates another example of a client system comprising three devices according to the invention.

The client system includes an access device, such as a tablet, D2 and two authentication devices: an Authenticator D3 and a primary authenticator D4.

The Authenticator D3 and the primary authenticator D4 may be any electronic devices with an interface allowing to get information from a user and able to communicate with the device D2. For instance, the authenticator D3 may be a mobile phone which communicates with the device D2 through a Bluetooth or USB link and the primary authenticator D4 may be a SD card or other secure element.

The authenticator D3 stores a secret data K which is used for wrapping/unwrapping the private key. The authenticator D3 includes an Authentication agent AA1 able to get an entry from the user and to authenticate the user thanks to this entry. For instance, the

Authentication agent AA1 may be configured to get a gesture and to check it. The authenticator D3 includes a Generation agent GA configured to generate a new key pair only in case of successful authentication of the user.

The primary authenticator D4 stores primary credentials PCR. The primary authenticator D4 includes an Authentication agent AA2 able to get an entry from the user and to authenticate the user thanks to the entry. For instance, the Authentication agent AA2 may be configured to get a password and to check it. The primary authenticator D4 includes a Derivation agent DA configured to derive a new certificate from the certificate of the primary credentials PCR only in case of successful authentication of the user.

The device D2 and the server are similar to those described at FIG. 3.

Preferably, the user agent UA, the WebApp, or both of the device D2 is designed to coordinate interaction between the Authenticator D3 and the primary authenticator D4.

Alternatively, both the Authenticator D3 and the primary authenticator D4 may be designed to communicate directly. For example they may communicate through a Bluetooth connection.

An example of interaction of the devices belonging to the client system is described below. When the user agent UA (e.g. browser) receives the registration request from the server, the user agent UA sends a message to Authenticator D3 for requesting key pair generation. The Authenticator D3 performs a user authentication thanks to its Authentication agent AA1 and in case of successful authentication, generates a new key pair thanks to the Generation agent GA. The Authenticator D3 wraps the new private key with the secret data K and sends the new public key and the wrapped new private key to the user agent UA.

Then the user agent UA sends a message (containing the new public key) to the primary authenticator D4 for requesting generation of a new certificate. The primary authenticator D4 performs a user authentication thanks to its Authentication agent AA2 and in case of successful authentication, derives a new certificate from the certificate of the primary credentials PCR. The primary authenticator D4 sends the new certificate and the certificate of the primary credentials to the user agent UA.

In one embodiment, the user agent UA sends the new certificate and the certificate of the primary credential to the Authenticator D3 for keeping. For future authentications, the user agent UA only needs to interact with the Authenticator D3. The primary authenticator D4 does not need to be present.

Then the device D2 builds a data structure (e.g. Key Handle) containing the new public key, the wrapped new private key, the new certificate and the certificate of the primary credentials and sends the bulk to the server.

In another embodiment (not drawn), the device D2 includes the features of the primary authenticator D4. In others words, the device D2 may include the features of the primary authenticator D4.

The authenticator may comprise several sets of credentials (for as many couple user/web applications). The plurality of web applications may be stored in the device D2 or through a set of several devices similar to D2. For instance one web application may be installed in a tablet, another one web application may be installed in a personal computer, while the corresponding credentials are stored in the smartphone of the user.

Thanks to the invention, the newly generated credentials can be verified and trusted in an easy way. By deriving the new credentials, the invention allows to maintain the same level of trust as the primary credentials.

It must be understood, within the scope of the invention that the above-described embodiments are provided as non-limitative examples. In particular, the client system may derive any number of credentials allowing to access as many services/servers.

1. A method for deploying credentials in a server and a client system including a first, a second and a third devices, wherein the second device comprises primary credentials including a public key, a private key and a primary certificate,
wherein, after a successful authentication of a user, the first device generates a new private key/public key pair and wraps the new private key,
wherein, after a successful authentication of said user, the second device derives a new certificate comprising the new public key, said new certificate having the same usage as specified in the primary certificate, wherein the second device signs the new certificate using the private key of the primary credentials,
wherein the third device forwards to the server the primary certificate and the new credentials combining the new public key, the wrapped private key and the new certificate,
wherein the server verifies the chain of trust of the new credentials and, in case of successful verification, associates the new credentials to said user.

2. A method according to claim 1, wherein said first device and said second device are merged in a single device.

3. A method according to claim 1, wherein the client system sends to the server a proof of genuineness of said first device.

4. A method according to claim 1, wherein the third device comprises a user agent which is configured to receive a registration request from the server, to send to the server a registration response comprising said primary certificate and new credentials and to coordinate interaction between said first and second devices.

5. A method for authenticating a user through an application to an authentication server, said application running on a client system including an authenticator device and a client device,
wherein the authentication server sends to the client system both a challenge and a bundle associated to a user for said application, said bundle including specific credentials which combine a public key, a wrapped private key and a certificate,
wherein, after a successful authentication of said user, the authenticator device verifies the validity of said bundle and, in case of successful verification, unwraps the private key, and generates a cryptogram by signing the challenge with the private key,
wherein the client system sends to the authentication server the cryptogram,
wherein the authentication server verifies the cryptogram using the public key and, in case of successful verification, authenticates the user to the authentication server.

6. A method for signing a value by a client system including a signing device and a client device,
wherein a server sends to the client system both the value and a bundle associated to a user, said bundle including specific credentials which combine a public key, a wrapped private key and a certificate,
wherein, after a successful authentication of said user, the signing device verifies the validity of said bundle, in case of successful verification, unwraps the private key and generates a signature by signing the value with the private key,
wherein the client system sends to the server the generated signature,
wherein the server verifies the signature using the specific public key.

7. A client system designed to communicate with a server and comprising a first device, a second device and a third device, the second device comprising primary credentials including a public key, a private key, and a primary certificate,
wherein said first device is configured to generate a new private key/public key pair and to wrap the new private key only in case of a successful authentication of a user,
wherein said second device is configured to derive a new certificate comprising the new public key only in case of successful authentication of said user, said new certificate having the same usage as specified in the primary certificate,
wherein the third device is configured to coordinate interaction between said first and second devices and to send to the server the primary certificate and the new credentials combining the new public key, the wrapped private key and the new certificate.

8. A client system according to claim 7, wherein said client system is configured to send to the server a proof of genuineness of said first device.

9. A client system according to claim 7, wherein said first device is configured to receive from the server a challenge and a bundle associated to the user, said bundle including specific credentials, wherein said first device is configured to authenticate said user and to verify the validity of said bundle in case of successful authentication of said user, and wherein the first device, in case of successful verification, unwraps the private key and generates a cryptogram by signing the challenge.

10. A client system according to claim 7, wherein said first device is configured to receive from the server a value and a bundle associated to the user, said bundle including specific credentials, wherein said first device is configured to authenticate said user and to verify the validity of said bundle in case of successful authentication of said user, and wherein the first device, in case of successful verification, unwraps the private key and generates a signature by signing the value with the private key.
